(19) United States
(12) Patent Application Publication
(10) Pub. No.: US 2026/0002553 A1
(43) Pub. Date: Jan. 1, 2026

(54) METHOD FOR OPERATING A HYDRAULIC SYSTEM OF AN INDUSTRIAL MACHINE

(71) Applicant: Baumueller Nuernberg GmbH, Nuernberg (DE)

(72) Inventors: Philipp GEBHARDT, Sulzbach-Rosenberg (DE); Michael STIEGLER, Kirchensittenbach (DE)

(73) Assignee: Baumueller Nuernberg GmbH, Nuernberg (DE)

(21) Appl. No.: 19/321,767

(22) Filed: Sep. 8, 2025

Related U.S. Application Data
(63) Continuation of application No. PCT/EP2024/053566, filed on Feb. 13, 2024.

(30) Foreign Application Priority Data
Mar. 7, 2023 (DE) 102023202043.2

(51) Int. Cl. F15B 15/18; B29C 45/53; B29C 45/82; F15B 19/00

(52) U.S. Cl. CPC F15B 15/18; B29C 45/531; B29C 45/82; F15B 19/00; B29C 2945/76006; B29C 2945/76163; B29C 2945/76334; B29C 2945/76381; B29C 2945/76498; B29C 2945/76812; B29C 2945/76859

(57) ABSTRACT

A method for operating a hydraulic system of an industrial machine, which hydraulic system comprises an actuator and a hydraulic pump which are connected fluidically via a hydraulic line which is assigned a pressure sensor. The hydraulic pump comprises an electric motor and a pump head driven by the latter. A pressure within the hydraulic line is measured via the pressure sensor, and a first pressure value is generated therefrom. A second pressure value is determined on the basis of operating data of the electric motor and a theoretical model. A fault is detected if the first pressure value differs from the second pressure value by more than a tolerance value. An industrial machine is also provided.

This nonprovisional application is a continuation of International Application No. PCT/EP2024/053566, which was filed on Feb. 13, 2024, and which claims priority to German Patent Application No. 10 2023 202 043.2, which was filed in Germany on Mar. 7, 2023, and which are both herein incorporated by reference.

### BACKGROUND OF THE INVENTION

### Field of the Invention

The present invention relates to a method for operating a hydraulic system of an industrial machine, and to an industrial machine having a hydraulic system. The hydraulic system includes an actuator and a hydraulic pump that are fluidically connected by means of a hydraulic line.

### Description of the Background Art

Industrial machines are used for producing or at least machining workpieces. In this regard, a comparatively large force is sometimes applied to a component of the industrial machine, and thus on the workpiece to be produced. For providing such forces, it is customary to use a hydraulic system having an actuator by means of which force is applied to the workpiece or some other part of the industrial machine that acts on the workpiece. The actuator is generally connected to a hydraulic pump by means of a hydraulic line, with a hydraulic fluid being conducted by the hydraulic line. A desired operating pressure is provided by use of the hydraulic pump, so that the actuator is moved as necessary.

The operating pressure must be suitably set in order for the actuator to move in a predetermined manner. To increase accuracy in machining of the workpiece, the operating pressure is controlled to a certain setpoint value by means of the hydraulic pump. It is thus necessary to measure the operating pressure that actually prevails in the hydraulic line, for which purpose a pressure sensor is used which is associated with the hydraulic line. During operation, an electrical line via which the hydraulic sensor is connected to the controller of the hydraulic pump may possibly be damaged, or the hydraulic sensor may be damaged, so that measured data can no longer be provided. To prevent an operating pressure of 0 bar to be erroneously assumed, which could lead to operation of the hydraulic pump that results in damage to the industrial machine, a pressure sensor is generally used, by means of which a sensor signal is provided as an offset, even for a pressure of 0 bar. It is thus possible to make a distinction concerning whether the pressure sensor is correctly connected to the controller, or whether there is no operating pressure in the hydraulic line. However, this increases manufacturing costs.

It is also possible for the electrical line which connects the pressure sensor to the controller to be exposed to electrical and/or magnetic fields, which then induce a voltage therein. Transmitted measured values are thus skewed, and consequently the actuator is not operated in the desired manner. To remedy this situation it is necessary to shield the electrical line, which further increases manufacturing costs.

### SUMMARY OF THE INVENTION

It is therefore an object of the present invention to provide a method for operating a hydraulic system of an industrial machine and to provide an industrial machine, wherein manufacturing costs are advantageously reduced and reliability is increased.

The method is used to operate a hydraulic system of an industrial machine. During operation, in particular a workpiece is produced or machined by use of the industrial machine. The industrial machine is suited, advantageously provided and configured, for this purpose. For example, the industrial machine is a roller, a press, or a cutting tool. The industrial machine is particularly preferably a molding machine, and is, for example, an injection molding machine.

The hydraulic system includes an actuator, by means of which a component of the industrial machine is moved during operation. For example, the actuator is in operative connection with a punch, a slider, a wheel, or a blade of the industrial machine, or the actuator itself forms the punch/blade/wheel or the like. At least the actuator is provided and configured to act on the workpiece to be produced/machined, for example directly or via some other component of the industrial machine, in particular a mechanical coupling being present between the workpiece and the actuator. In particular, the actuator can be mechanically fastened, in particular rigidly, to the other component. The industrial machine is preferably an injection molding machine, and a slider, a tool, a valve, and/or a worm gear, for example, are/is moved by means of the actuator, or the actuator forms these in each case, at least in part.

The hydraulic system can also includes a hydraulic pump that is fluidically connected to the actuator via a hydraulic line. A hydraulic fluid, in particular an oil, is conducted by the hydraulic line during operation, a pressure being generated in the hydraulic fluid by means of the hydraulic pump. In particular, by means of the hydraulic pump an operating pressure, also referred to below simply as “pressure,” which acts on the actuator is set in the hydraulic line. The fluidic connection is preferably such that the actuator is moved in a desired manner due to the operating pressure provided by the hydraulic pump. For example, a valve or some other adjustment unit, which is additionally appropriately actuated for this purpose, is introduced into the hydraulic line.

For example, the hydraulic system can be formed solely by the actuator, the hydraulic pump, and the hydraulic line. Alternatively, even further hydraulic lines are present via which the hydraulic pump is connected to the actuator, so that the actuator may be moved in different directions and/or in different ways. The hydraulic system also particularly preferably includes a reservoir for the hydraulic fluid and/or an excess pressure compensation vessel, so that the formation of excess pressure, excessive peak pressures, or the like in the hydraulic system is avoided. Alternatively or in combination therewith, a pressure relief valve may be present which opens, for example, when the operating pressure exceeds a pressure limit, so that the excess pressure is reduced, thus avoiding damage. The industrial machine or at least the hydraulic system is advantageously suited, in particular provided and configured, so that the maximum pressure or nominal pressure during normal operation is between 100 bar and 400 bar. In particular, the pressure relief valve which is possibly present is adapted thereto. For example, the hydraulic system also includes one or more further actuators that are fluidically connected to the hydraulic pump via the or at least one hydraulic line. It is thus possible to operate multiple such actuators by means of the hydraulic pump.

The hydraulic pump can include an electric motor and a pump head driven by same. The electric motor advantageously has a brushless design, and is a brushless direct current (BLDC) motor, for example, or at least a synchronous motor. In particular, the electrical power of the electric motor is between 200 W and 500 kW. In particular, the hydraulic pump has a converter or servo drive by means of which the electric motor is energized. The converter/servo drive advantageously has a bridge circuit, for example a B6 circuit.

During operation, a portion of the hydraulic fluid is advantageously present in the pump head, by means of which, for example, the hydraulic fluid can be pumped during operation of the electric motor. For example, the pump head can include an impeller or gear drive for this purpose. Alternatively, the pump head includes an axial piston or punch/slider, for example, which is moved in a longitudinal direction during operation of the electric motor, so that intermittent pumping of the hydraulic fluid takes place. In particular, the pump head has an inlet and an outlet, at least one of which is fluidically connected to the hydraulic line.

The hydraulic system also includes a pressure sensor that is associated with the hydraulic line. The pressure sensor is suited, in particular provided and configured, for measuring a pressure prevailing within the hydraulic line, in particular the pressure of the hydraulic fluid. The measured pressure is the static pressure, the dynamic pressure, or the total pressure, for example. The pressure sensor is preferably situated on the high-pressure side of the hydraulic pump, so that the operating pressure provided by means of the hydraulic pump may be measured by the pressure sensor. For example, the pressure sensor is spaced apart from the hydraulic pump or, for example, is partially inserted into the hydraulic pump, in particular the pump head. Installation as a module is thus made possible. Alternatively, the pressure sensor is situated in the area of the actuator, for example, so that the pressure, by means of which the actuator is operated, may essentially be determined.

The method provides that a pressure within the hydraulic line is measured by means of the pressure sensor, and on this basis a first pressure value is generated. Thus, by means of the pressure sensor the operating pressure prevailing in the hydraulic line and/or the operating pressure of the hydraulic fluid are/is measured. In particular, the measured value generated by means of the pressure sensor is used as the first pressure value. Alternatively, a value derived therefrom, or at least a corresponding value, for example a voltage provided by means of the pressure sensor, is used.

Furthermore, a second pressure value can be determined based on operating data of the electric motor and of a theoretical model. For this purpose, in particular the operating data of the electric motor are initially detected and preferably measured. For example, a rotational speed of the electric motor, power applied by the electric motor, an electrical current conducted by the electric motor, and/or a voltage present at the electric motor are/is used as corresponding operating data. The operating data in particular are already present, and are used, for example, to control the hydraulic pump, preferably of the electric motor, and/or to determine the particular state of the hydraulic pump.

The theoretical model in particular is a so-called digital twin of the industrial machine or at least of the hydraulic system. However, the second pressure value is determinable at least based on the theoretical model, which in particular is static, and the dynamically changing operating data, and is determined according to the method. The second pressure value corresponds to the assumed pressure within the hydraulic line which results during operation of the electric motor with the corresponding operating data. In other words, the second pressure value is the theoretical pressure that results from operation of the electric motor. The second pressure value is not a setpoint value, and instead changes as a function of the operating data, which in particular are measured. By use of the theoretical model, an inertia or friction of the hydraulic fluid or some other components of the hydraulic system and/or an efficiency of the electric motor and/or of the pump head, for example, are/is preferably taken into account. In particular, the theoretical model includes one or more differential equations of motion of the industrial machine.

A fault is detected if the first pressure value differs from the second pressure value by more than a tolerance value. For this purpose, in particular the difference between the two pressure values is generated and compared to the tolerance value. In particular, the absolute value of the difference is used so that the comparison does not have an algebraic sign. The tolerance value is in particular greater than 1 bar and preferably less than 20 bar. In particular, the tolerance value is 10 bar. It is thus possible to use a simplified theoretical model in which slight fluctuations in the first pressure value, for example due to manufacturing tolerances, are not taken into account, without the fault being incorrectly detected.

By use of the method, in particular plausibility checking of the first pressure value generated by means of the pressure sensor thus takes place. A failure of the pressure sensor, for example due to a pulled-off electrical line, may thus be identified, even without the pressure sensor having a measured value for a pressure that is not present. It is thus possible to use a pressure sensor which is comparatively inexpensive or already present, and which in particular is also used for the hydraulic system and which in particular supplies a measured value of 0 A or 0 V at a pressure of 0 bar. It is also thus possible to recognize distorted measuring signals that are provided by the pressure sensor. The distortion occurs, for example, due to damage to the electrical line that is possibly present and/or due to in-coupling of interference signals, in particular on account of an induced voltage. In other words, a disturbance of the hydraulic system and thus of the industrial machine is detectable by use of the method, namely, when the fault, in particular an implausible sensor value, is detected. It is thus possible to respond and take appropriate actions so that, for example, damage to the industrial machine is avoided, and/or discarding of the tools thus machined/produced and/or downtime are/is reduced.

For example, the fault may always be detected as soon as the first pressure value differs from the second pressure value by more than the tolerance value. However, it is particularly preferred that the fault is detected only if the two pressure values differ from one another by more than the tolerance value for a predefined time period. It is in particular irrelevant how the deviation changes within the time period, as long as the deviation is greater than the tolerance value. The predefined time period is preferably constant or, for example, a function of the present operating point of the hydraulic system. In particular, the time period is greater than 0.1 second and less than 10 seconds. The time period is advantageously equal to 1 second or 2 seconds. This ensures that a comparatively brief fluctuation in the pressure, i.e., a temporary change in the first pressure value, does not result in detection of a fault. Such a change is caused, for example, by a desired change in the operation of the actuator, for example when a movement of the actuator starts or ends. Consequently, it is not necessary to store this behavior in the theoretical model, which thus simplifies the theoretical model. In addition, determination of the second pressure value is speeded up and is comparatively robust.

The hydraulic pump can be controlled to a setpoint value if no fault is detected. During the control of the hydraulic pump to the setpoint value, the first pressure value is used as the actual value. Based on the control, the difference between the first pressure value and the setpoint value is thus minimized. The setpoint value is specified in particular based on a higher-order regulation or control by means of which in particular the operation of the actuator takes place. By use of the setpoint value, namely, a certain pressure, preferably a parameter on the basis of which the electric motor is operated, such as an electrical current conducted by the electric motor and/or a rotational speed, is derived. A lower-order control is advantageously present by means of which the control of the electric motor to the corresponding parameters takes place. The, or a portion of the, operating data of the electric motor used to determine the second pressure value are/is advantageously used for the lower-order control. Due to the control of the hydraulic pump, the actuator is moved in a desired manner so that activities performed by the industrial machine are essentially as intended.

For example, after the fault is detected the hydraulic pump is essentially immediately shut down. Thus, the pressure in the hydraulic system is not further increased. However, it is particularly preferred that after the fault is detected, the hydraulic pump continues to be operated, so that a pressure still prevails in the hydraulic system and is optionally increased. The hydraulic pump continues to be operated until the actuator has a predetermined state. In other words, due to operating the hydraulic pump, the actuator moves and is brought into predetermined state, even after the fault is detected. When the actuator is in the predetermined state, the operation of the hydraulic pump is ended, and the actuator is thus left in the predetermined state.

The predetermined state is a state from which in particular restarting of the industrial machine is possible or facilitated. For example, for this purpose the actuator is placed in a parked position. After the fault is eliminated, for example after replacement or repair of the pressure sensor, restarting the industrial machine is thus simplified without the need for even further extensive operations in addition to the repair/replacement of the pressure sensor. If the industrial machine is an injection molding machine, for example, in order to reach the predetermined state essentially the entire quantity of molten plastic still present is discarded, and/or plastic that is present in a casting mold is removed, so that comparatively time-intensive cleaning is not necessary afterwards.

For example, an end of an operating cycle can be used as the predetermined state. The actuator is then advantageously in a starting or reference position. In other words, the present work step/the present work operations at the particular workpiece, during whose machining/production the fault has been detected, is/are completed so that the operating cycle is ended. Although it is very likely that this workpiece is defective and cannot be reused, the actuator is subsequently at the beginning of a new operating cycle, so that after the fault is eliminated the industrial machines may be used essentially immediately for the machining/production of a new workpiece. It is also not necessary to specify a separate predetermined state that is started only in the event of a fault, for example, which reduces complexity.

For example, after the fault is detected the hydraulic pump is placed in controlled operation. However, the hydraulic pump is particularly preferably controlled to a further setpoint value, using the second pressure value as the actual value. This ensures that, despite continuing to operate the hydraulic pump after the fault is detected, no excessive pressure forms in the hydraulic system and/or no undesirable behavior of the actuator occurs. It is also not necessary, for example, for the hydraulic pump settings to be known in advance for an operating cycle in order to move the actuator into the predetermined state, for example; instead, this takes place by means of the (dynamic) control to the further setpoint value, for which purpose in particular the actual value generated from the second pressure value is used. In particular, it is not necessary for the operating variables for a machine cycle to be known in advance. Thus, (continued) operation is possible, even without a further setpoint value.

It may also be possible to continue to use the industrial machine after the fault is detected, for example, also if reduced quality of the produced/machined workpieces is permissible. In this case, for example the hydraulic pump is controlled, based on the second pressure value, until the pressure sensor or possibly a line associated with the pressure sensor has been replaced/repaired. This takes place, for example, during the continued operation of the industrial machine, or the industrial machine is temporarily shut down for this purpose. The control is subsequently continued, using the pressure value that has been generated by the replaced pressure sensor. Thus, for example, shutting down the entire industrial machine is not necessary. For example, the further setpoint value corresponds to the setpoint value. However, it is particularly preferred that the further setpoint value is different from the setpoint value, and for example is derived from the setpoint value and advantageously corresponds to slower operation of the industrial machine, thus reducing load on the industrial machine. In particular, the further setpoint value is such that the accuracy in determining the second pressure value is increased.

During operation of the hydraulic system, it is particularly preferred that controlled operation of the hydraulic pump to a particular setpoint value always takes place, with the first pressure value being used as the actual value if no fault is present, and the second pressure value being used as the actual value if a fault has been detected.

For example, after the fault is detected the particular required pressure is maintained. However, after the fault is detected the pressure is preferably reduced. If the industrial machine, in particular the hydraulic system, continues to be operated, this takes place in particular at a reduced pressure. For this purpose, in particular a valve is actuated so that initially an at least smaller pressure reduction takes place. Alternatively, the pressure is reduced via the hydraulic pump. For example, the pressure is reduced to a value between 90% and 50% of the pressure prevailing before the fault was detected. This decreases hazards to objects present in the surroundings of the industrial machine or at least of the hydraulic system if the damage to the pressure sensor resulted, for example, from overload and/or leakage. In particular, the possible further setpoint value is adapted to the reduced pressure. In particular, slower movement of the actuator occurs due to the reduced pressure.

The industrial machine includes a hydraulic system having an actuator and a hydraulic pump that are fluidically connected by means of a hydraulic line with which a pressure sensor is associated. For example, the hydraulic line is at least partially made of a rubber and is thus flexible. Alternatively or in combination therewith, the hydraulic line, at least in sections, is produced using a tube made of a plastic or a metal, for example. The hydraulic pump includes an electric motor and a pump head driven by same. In particular, the hydraulic pump includes a servo drive/converter by means of which the electric motor is operated.

The hydraulic system can be operated according to a method in which a pressure within the hydraulic line is measured by means of the pressure sensor, and on this basis a first pressure value is generated. A second pressure value is determined based on operating data of the electric motor and of a theoretical model. A fault is detected if the first pressure value differs from the second pressure value by more than a tolerance value.

The hydraulic system, for example a possible servo drive/converter, advantageously has a control unit that is suited, in particular provided and configured, for carrying out the method. The control unit includes, for example, an application-specific integrated circuit (ASIC) or particularly preferably a computer having a suitably programmable design. In particular, the control unit includes a memory medium on which a computer program product, also referred to as a computer program, is stored, wherein when this computer program product, i.e., the program, is executed, the computer is prompted to carry out the method. The invention further relates to such a hydraulic system.

The industrial machine is advantageously a component of an industrial facility which includes, for example, multiple such industrial machines or some other industrial machines. The industrial machine is used, for example, to produce and/or machine a workpiece, and is a (hydraulic) press, for example. A punch/slider is advantageously formed or at least driven by means of the actuator. Alternatively, the industrial machine is a cutting machine, for example, and a blade, for example, is driven by means of the actuator. The industrial machine is particularly preferably a plastic injection molding machine, and by means of the actuator, for example a screw conveyor and/or a punch/slider are/is driven, by means of which a liquefied plastic is injected into a casting mold. Alternatively or in combination therewith, the actuator is associated with the casting mold, for example, by means of which the casting mold is, for example, opened or moved in some other way. In particular, the hydraulic system includes multiple corresponding actuators which preferably are associated with the same industrial machine, with only a single hydraulic pump being present. Manufacturing costs are reduced in this way.

The invention further relates to a computer program product. The computer program product includes a number of commands which, when the program (computer program product) is executed by a computer, prompt the computer to carry out a method for operating a hydraulic system of an industrial machine. The hydraulic system includes an actuator and a hydraulic pump that are fluidically connected by means of a hydraulic line with which a pressure sensor is associated. The hydraulic pump includes an electric motor and a pump head driven by same. In the method, the pressure sensor is used to measure a pressure within the hydraulic line, and on this basis a first pressure value is generated. A second pressure value is determined based on operating data of the electric motor and of a theoretical model, and a fault is detected if the first pressure value differs from the second pressure value by more than a tolerance value.

The computer is advantageously a component of a control unit and is formed by same, for example. The computer preferably includes a microprocessor or is formed by same. The computer program product is, for example, a file or a data medium that contains an executable program which automatically carries out the method when installed on a computer.

The invention further relates to a memory medium on which the computer program product is stored. A CD-ROM, a DVD, or a Blu-ray disc is an example of such a memory medium. Alternatively, the memory medium is a USB stick, an SD card, or some other memory which is rewritable, or writable only once, for example. A flash memory, a RAM, or a ROM is an example of such a memory.

The refinements and advantages explained in conjunction with the method are analogously transferable to the industrial machine/the hydraulic system/the control unit/the computer program product/the memory medium and among one another, and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows an industrial machine with a hydraulic system; and

FIG. 2 shows a method for operating the hydraulic system.

### DETAILED DESCRIPTION

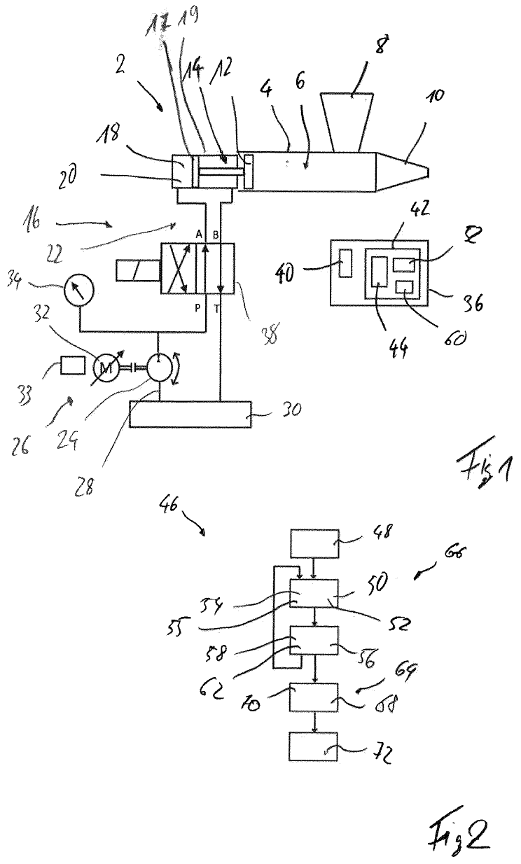

FIG. 1 is a schematically simplified illustration of an industrial machine 2 in the form of an injection molding machine. The industrial machine 2 has a cavity 6 which is provided by means of a housing 4, and into which a filling funnel 8 opens. The cavity 6 opens into a nozzle 10, at the end of which a casting mold, not illustrated in greater detail, is situated during operation. The cavity 6 is delimited by a movable slider 12 on the side opposite from the nozzle 10.

The slider 12 is a component of an actuator 14 of a hydraulic system 16. A piston 17 of the actuator 14 is fastened to the slider 12 on the side thereof opposite from the cavity 6. A working volume 18 of the actuator 14 that is present in a further housing 19 of the actuator 14 is partially delimited by the piston 17. The piston 17 is longitudinally movably supported by means of the further housing 19, so that the size of the working volume 18, which is filled with a hydraulic fluid 20 of the hydraulic system 16, may be changed. When hydraulic fluid 20 is pumped into the working volume 18, the size of the working volume increases, and the piston 17 and therefore also the slider 12 are moved. As a result, the volume of the cavity 6 is decreased, so that plastic (not illustrated in greater detail) that is present in the cavity 6 is pressed through the nozzle 10.

The hydraulic system 16 includes a hydraulic line 22 by means of which the working volume 18 and a pump head 24 of a hydraulic pump 26 of the hydraulic system 16 are fluidically connected. The hydraulic line 22 is connected on the high-pressure side of the pump head 24. On the low-pressure side a further hydraulic line 28 is fluidically connected to the pump head 24, and by means of the further hydraulic line the pump head 24 is connected to a reservoir 30 in which the hydraulic fluid 20 is likewise present. During operation of the pump head 24, the hydraulic fluid 20 is pumped from the reservoir 30 and into the working volume 18, so that the piston 17 is moved. The pressure of the hydraulic fluid 20 prevailing in the hydraulic line 22 is hereby increased to 200 bar. For driving the pump head 24, the hydraulic pump 26 has an electric motor 32, which is a brushless direct current motor. The electric motor 32 is energized by means of a servo drive 33 or converter of the hydraulic pump 26.

Associated with the hydraulic line 26 is a pressure sensor 34 by means of which the pressure prevailing in the hydraulic line 22 can be measured. For this purpose the pressure sensor 34 is fluidically connected, or at least connected with respect to pressure, to the hydraulic line 22. The pressure sensor 34 is connected, for signaling purposes, to a control unit 36 by means of which the hydraulic system 16 is operated. For this purpose the control unit 36 is connected to the servo drive 33, and the servo drive 33 is appropriately adjusted by means of the control unit 36 so that the electric motor 32 is energized according to certain specifications. Also associated with the hydraulic line 22 is a valve 38 which likewise is connected, for signaling purposes, to the control unit 36, so that the valve 38 may be switched by means of the control unit 36. It is possible to use the valve 38 to discharge hydraulic fluid 20 present in the working volume 18, thus decreasing the pressure prevailing therein. By appropriately adjusting the valve 38 it is also possible to pump the hydraulic fluid 20 to the side of the piston 17 opposite from the working volume 18, so that the piston, and thus also the slider 12, are moved away from the nozzle 10.

The control unit 36 includes a computer 40 in the form of a programmable microprocessor. In addition, the control unit 36 includes a memory medium in the form a memory 42 on which a computer program product 44 is stored. The computer program product 44 includes a number of commands which, when the program is executed by the computer 40, prompt the computer to carry out a method 46, illustrated in FIG. 2, for operating the hydraulic system 16. The hydraulic system 16 is thus operated according to the method 46, and the control unit 36 is provided and configured to at least partially carry out the method 46.

The method 46 is started in a first work step 48. At the beginning of the first work step 48, the slider 12 is situated at the farthest position from the nozzle 10 which the slider 12 can assume, so that the working volume 18 is minimal. In addition, no plastic is present in the cavity 6. When the method 46 is started, a plastic is filled in via the filling funnel 8, and in a subsequent, second work step 50 the hydraulic pump 26 is controlled to a setpoint value 52 by means of the control unit 36, so that a pressure is built up in the hydraulic line 22 which causes the piston 17, and thus also the slider 12, to move in the housing 4. As a result, the plastic present in the cavity 6 is pressed out through the nozzle 10. The setpoint value 52 is stored within the memory 42, and varies as a function of the position of the slider 12 in the housing 4. The setpoint value 52 is also adapted to the plastic used and to the casting mold used, which is connected to the nozzle 10.

The pressure within the hydraulic line 22 is measured by means of the pressure sensor 34, and on this basis a first pressure value 54 is generated. The first pressure value 54 corresponds to the pressure prevailing in the hydraulic line 22, and is used as the actual value for the control. In other words, by changing the setting of the operation of the electric motor 32, the pressure in the hydraulic line 22 and thus also the newly generated first pressure value 54 are changed until the first pressure value corresponds to the setpoint value 52 that is valid at that time. The energization of the electric motor 32 is thus adapted, for which purpose a lower-order control is used. Based on the difference between the setpoint value 52 and the first pressure value 54, power to be applied by the electric motor 32 as well as an electrical current, necessary for this purpose, to be conducted by the electric motor 32 are determined. On this basis, a voltage to be applied to the electric motor 32 is determined. For the lower-order control on the power to be applied/the electrical current/the voltage, operating data 55, which are measured by means of sensors (not illustrated in greater detail), are used as the respective actual values. A present rotational speed of the electric motor 32 as well as a present electrical current that is conducted by the electric motor 32 and/or the voltage that is present at the time are used as operating data 55.

In a third work step 56 that is carried out essentially concurrently with the second work step 50, the first pressure value 54 is compared to a second pressure value 58. The second pressure value is determined, namely, calculated, based on the operating data 55 and a theoretical model 60 that is stored in the memory 42. In summary, the second pressure value 58 is determined based on the operating data 55 of the electric motor 32 and of the theoretical model 60. The second pressure value 58 is thus a theoretical value, and corresponds to the pressure within the hydraulic line 22 that would result due to operation of the hydraulic pump 26, if no malfunction or the like were present.

The difference between the second pressure value 58 and the first pressure value 54 is determined. For this purpose, the absolute value of the difference between the two pressure values 54, 58 is determined. The difference is compared to a tolerance value 62. A fault 64 is detected if the first pressure value 54 differs from the second pressure value 58 by more than the tolerance value 62. The tolerance value 62 is 10 bar here. The fault 64 is detected only if the difference exceeds the tolerance value 62 for a predefined time period. The predefined time period is 1 second here. Thus, if the difference is greater than the tolerance value 62 for only 0.1 second, the fault 64 is not detected. In summary, the fault 64 is detected only if the first pressure value 54 differs from the second pressure value 58 by more than the tolerance value 62 for the predefined time period.

If the fault 64 is not present, the second work step 50 and the third work step 56 are carried out again, namely, until the slider 12 rests against the nozzle 10 or reaches an end position there. The hydraulic pump 26 is subsequently used to reduce the hydraulic fluid 20 from the working volume 18 until the working volume is minimal. For this purpose the valve 38 is switched, and the hydraulic fluid 20 present in the working volume 18 is discharged into the reservoir 30. In addition, the hydraulic fluid 20 is pumped into the space in the further housing 19 opposite from the working volume 18, so that the piston 17 is moved. The slider 12 is then once again in the position farthest from the nozzle 10. A work cycle/operating cycle 66 is then ended. The first through third work steps 48, 50, 56 are subsequently carried out once again. Alternatively, the industrial machine 2 is shut down and the operating cycle 66 is once again carried out only when necessary. Due to the termination of the operating cycle 66 and the position of the slider 12, there is no more plastic in the cavity 6 after each operating cycle 66 terminates, so that in each case a new operating cycle 66 may be started essentially immediately.

If the fault 64 has been detected, a malfunction of the pressure sensor 34 is present, so that the measured data thus generated, and therefore also the first pressure value 52, are incorrect. The control of the hydraulic pump is thus also incorrect, and the injection-molded parts produced using the industrial machine 2 are defective goods.

After the fault 64 has been detected, a fourth work step 68 is carried out. In this step, the hydraulic pump 26 continues to be operated and is controlled to a further setpoint value 70. The further setpoint value 70 differs from the setpoint value 52, but is derived therefrom. The further setpoint value 70 corresponds to a decreased movement speed of the slider 12; however, movement of the slider 12 occurs. As a result, the further setpoint value 70 is lower than the setpoint value 52. Therefore, initially the valve 38 is actuated, and the pressure of the hydraulic fluid present in the hydraulic line 22 is reduced. Alternatively, the reduction in the pressure takes place via the hydraulic pump 26.

The second pressure value 58 is used for the control to the further setpoint value 70. The second pressure value 58 is used as the actual value of the control, and the energization of the electric motor 32 is adapted based on the difference between the second pressure value 58 and the further setpoint value 70. The control of the electrical current used for this purpose is also continued. The fourth work step 68 is carried out until the slider 12 has likewise been moved to the stop against the nozzle 10, which is stored in the further setpoint value 70. As a result, the plastic present in the cavity 6 is pressed out through the nozzle 10. The time window until the slider 12 is present there, in comparison to using the setpoint value 52 and the case that no fault 64 is present, is increased. The slider 12 is subsequently spaced apart from the nozzle 10 until the working volume 18 is minimal, for which purpose the valve 38 is switched so that the hydraulic fluid 20 present in the working volume 18 is pumped back into the reservoir 30 by means of the hydraulic pump 26. Consequently, the operating cycle 66 during which the fault 64 has occurred is terminated.

A fifth work step 72 is carried out, and the hydraulic pump 26 is shut down and the method 46 is ended. In other words, after the fault 64 is detected the hydraulic pump 26 continues to be operated until the actuator 14 has a predetermined state. The predetermined state corresponds to the end of the operating cycle 66. Since the industrial machine 2 is subsequently in the same state as when the method 46 started, with the exception of the damaged pressure sensor 34, it is possible for the industrial machine 2 to be restarted essentially immediately after the pressure sensor 34 is replaced or repaired, and time-consuming, costly cleaning of the cavity 6 to remove plastic residues still present is not necessary.

The invention is not limited to the exemplary embodiment described above. Rather, other variants of the invention may also be derived by those skilled in the art without departing from the subject matter of the invention. In particular, all individual features described in conjunction with the exemplary embodiment may also be combined with one another in some other way without departing from the subject matter of the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method to operate a hydraulic system of an industrial machine comprising an actuator and a hydraulic pump that are fluidically connected via a hydraulic line with which a pressure sensor is associated, the hydraulic pump comprising an electric motor and a pump head driven by the electric motor, the method comprising:
measuring a pressure within the hydraulic line via the pressure sensor;
generating a first pressure value based on the measured pressure;
determining a second pressure value based on operating data of the electric motor and of a theoretical model; and
detecting a fault if the first pressure value differs from the second pressure value by more than a tolerance value.

2. The method according to claim 1, wherein the fault is detected only if the first pressure value differs from the second pressure value by more than the tolerance value for a predefined time period.

3. The method according to claim 1, wherein the hydraulic pump is controlled to a setpoint value, the first pressure value being used as the actual value if no fault is detected.

4. The method according to claim 1, wherein, after the fault is detected, the hydraulic pump continues to be operated until the actuator has a predetermined state.

5. The method according to claim 4, wherein an end of an operating cycle is used as the predetermined state.

6. The method according to claim 4, wherein the hydraulic pump is controlled to a further setpoint value using the second pressure value as the actual value.

7. The method according to claim 1, wherein, after the fault is detected, a pressure is reduced.

8. An industrial machine comprising:
a hydraulic system having an actuator and a hydraulic pump that are fluidically connected via a hydraulic line with which a pressure sensor is associated, the hydraulic pump comprising an electric motor and a pump head driven by the electric motor,
wherein the hydraulic system is operated according to the method according to claim 1.

9. The industrial machine according to claim 9, wherein the industrial machine is an injection molding machine.
